(19) United States
(12) Patent Application Publication
(10) Pub. No.: US 2002/0162278 A1
(43) Pub. Date: Nov. 7, 2002

(54) WINDOW OR DOOR INCLUDING A HIGH PERFORMANCE THIN INSULATING GLAZING FITTED TO A WALL SURFACE

(76) Inventors: YVES DEMARS, CLERMONT (FR); RENE POIX, NOYON (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/021,565

(22) Filed: Feb. 10, 1998

(30) Foreign Application Priority Data
Feb. 13, 1997 (FR) 97/01 664

(51) Int. Cl. E05C 7/02

(52) U.S. Cl. 49/67

(57) ABSTRACT

A window or door has at least one folding panel or sliding door and a frame is installed in a chamber wall including an opening to be closed. The edges of the window or door are fixed on the chamber wall to be closed such that the window or door remains parallel to the wall and is not inserted into the thickness of the wall. Thus, there is no empty space to fill up, and the operation of creating a seal, which is often difficult to carry out successfully, is no longer necessary.

### BACKGROUND OF THE INVENTION

1. Field of the Invention

The present invention concerns a new design of a window or door, including a high performance thin insulating glazing, for example a glazing under vacuum.

2. Description of the Related Art

Creating windows to form a chassis or frame, for example of wood, aluminum, polyvinyl chloride (PVC), etc. in an opening formed in the masonry of a chamber, such in a building, and forming one or more folding panels which will be inserted at least partially into the thickness of the wall of the chamber, is known. This insertion, at least partial, is necessary due to the thickness of the glazing and consequently of the window, when using an insulating window formed by two sheets of glass separated by a thin layer of gas.

The installation of these windows can pose some problems, particularly of tolerances. The tolerances permitted for the masonry are on the order of centimeters, while those of the windows are of the order of millimeters. It is therefore always necessary during installation to be sure to fill up the space which can exist between the window and the masonry to guarantee perfect tightness.

Moreover, to install such windows, it is necessary to make dimensions of the opening to be filled correspond to standard window dimensions. Conversely, when the dimensions of the opening in the wall do not correspond to those of standard windows, it is necessary to make the windows to order, which increases the manufacturing cost of the window.

### SUMMARY OF THE INVENTION

It is an object of the invention to provide a window or door whose installation is simplified and does not require a step of filling in a space, and thereby guaranteeing tightness, and the dimensions of which are adaptable to a range of dimensions of the wall opening.

According to the invention, the window or door having at least one folding panel or sliding door and a frame is such that it is installed in a chamber wall including an opening to be closed. The edges of the window or door are fixed on the chamber wall to be closed such that the window or door remains parallel to the wall and is not inserted into the thickness of the wall. Thus, there is no empty space to fill up, and the operation of creating a seal, which is often difficult to carry out successfully, is no longer necessary.

According to a variant of the invention, the window or door is installed on the chamber wall interior side. According to a second variant, it is installed on the chamber wall exterior side, and according to a third variant, it is installed on a jamb situated in the thickness of the chamber wall. These three variants correspond respectively to different criteria of insulation and aesthetics.

According to a preferred embodiment, the frame of the window or door is realized in situ, that is, during the installation of the window or door. It is made on site and is directly fixed on the wall. Such a frame is, for example, composed of panels or sheets of wood, aluminum, PVC, etc., directly fixed on the masonry by any known method, for example by screws. The frame contributes to the lining of the window and also permits the installation of hardware elements used in the opening and closing of the window, such as hinges, latches, etc.

According to an advantageous variant of the invention, the frame includes systems for adjusting the support thereof on the wall, mitigating any unevenness in the masonry. Such adjustment systems comprise, for example, blocks inserted inside attachment holes created in the frame for fixing it into the masonry. In this way, the frame remains parallel to the plane of the wall. All other known adjustment systems can be used to mitigate faults in the evenness of the masonry.

According to another advantageous variant of the invention, the frame of the window or door has a leveling system for the frame in relation to the opening. Such a leveling system can be any known system, such as for example, a beveled block system with support screw. According to this beveled block system, the frame rests on this block, itself supported on the edge of the opening, and by adjusting the support screw, one adjusts the height of the frame. This way, the frame is positioned in relation to the opening of the bay and to the horizontal.

According to a preferred embodiment of the invention, seals are arranged on the face of the frame facing the wall having the opening, these seals being compressed when the frame is installed on the wall. This seal compression provides a good tightness between the masonry and the frame. The seals are, for example, made of polyvinyl chloride (PVC), polyurethane (PU), which may be expanded or not, silicone, ethylene-propylene-diene monomer (EPDM) and any other known material. Preferably, a peripheral finishing of the sealing between the frame and the wall is conducted by depositing a mastic type connection. This finishing permits enhanced tightness.

According to a variant of the invention, the sash of the window or door is installed on the frame of the respective window or door, and so is on a plane parallel to the frame. This is advantageous during installation of the window or door because, in contrast to classical windows, it is not necessary to install it as a whole and at one time in the opening in order to avoid any risk of deformation. The sash may comprise a glass structure, itself consisting of at least one sheet of glass. Preferably the glass structure is an insulating glazing under vacuum. Such a glazing consists of two sheets of glass separated by a space in which a vacuum is created and is specifically described in patent application EP-A-645 516.

Such a glazing presents different advantages for different applications. It has a narrow width which permits creating a window whose sash can simply be supported on the frame without creating a significant additional thickness which would be unacceptable, if only from an aesthetic point of view. Also, the structure of such a glazing gives it a sufficient rigidity and a stability so that it is not necessary to associate a framework with it to form the sash, which of itself would lead to a very significant thickness, as in conventionally manufactured insulating windows.

According to a preferred embodiment of the invention, the dimensions of the glass structure are at least as large as those of the opening to be closed.

According to a variant of the invention, the sash includes a lining on the periphery of at least one face of the insulating glazing. This lining can be applied to the face of the glazing face oriented either toward the interior of the chamber or toward the outside, or even on the periphery both faces of the glazing. It may be constructed of wood panels matched with those of the frame, or of aluminum or plastic material such as PVC, or in any other known manner. Such a lining permits masking the peripheral seal of the glazing and accommodating hardware elements such as hinges or latches which complement those of the frame.

According to an advantageous variant of the invention, the lining of the insulating glazing is accomplished by bonding. Thus when the lining is created on both faces of the glazing, two linings of different materials can be joined to the same glazing. To permit a stable and effective fixation of the glass structure and of the jamb(s) used for the lining over time (the window or door being destined for frequent manipulation), it is important that the adhesive used for the bonding present certain mechanical characteristics after hardening, these characteristics depending upon the bonding surface used. Specifically, the adhesive should be inversely proportional to the bonding surface used, e.g., a shearing resistance greater than 0.1 kg/cm² for a bonding surface of 2000 cm², a shearing resistance greater than 0.25 kg/cm² for a bonding surface of 800 cm², a shearing resistance greater than 0.5 kg/cm² for a bonding surface of 400 cm². The adhesive should have a resistance to heat of at least 130° C.

The adhesive used to bond the glass structure to the jambs used for the lining is, for example, a single component or dual component silicone, a single component or dual component acrylic and/or methacrylic adhesive, a polyurethane adhesive, etc. The adhesive having such characteristics guarantees that the glass will hold to the jambs and accommodate and support the stresses to which the glass is subjected during manipulations of the sash. The adhesive is distributed in the space delimited by the glass structure and the jambs of the lining, the thickness and width of the adhesive depending on the type of adhesive used. By “thickness” of the adhesive is understood the mean the distance between the surface of the glass and the surface of the jamb of the lining opposite it. The “width” of the adhesive is the width on which the glass is bonded, this width being less that the distance from the extremity of the jamb of the lining to the central core of the jamb.

Other bondings can be envisioned with different with different adhesives, and can even be applied directly between the jamb of the lining and the glass structure without adding adhesive. In particular, when the lining jamb is of acrylic and/or methacrylic material, the bonding can be made directly. The acrylic and/or methacrylic material can serve as adhesive, being placed in contact with the glass before hardening.

According to another variant, the lining of the glazing is created by embedding the glazing in grooves previously made in the lining.

A lining on one side and the other of the glazing, that is on the two faces, permits improvement of the thermal insulation at the level of the peripheral sealing of the glazing, this zone of the glazing being the most vulnerable. The lining may be a material such as wood, polyvinyl chloride, polyurethane, aluminum, an acrylic and/or methacrylic resin, an agglomerated or composite material or a mixture of two or several of these materials. In creating a lining of a mixture of two or more of these materials, it is possible to diminish the volume of high cost noble materials used by lining one face with this noble material and the other face with a less costly material.

According to a variant of the invention, the viewing aperture of the window or door is of a dimension almost identical with that of the opening. By viewing aperture is understood the transparent zone of the ensemble as a whole. This permits optimizing the dimensions of the opening and maximizing the amount of light entering the chamber. This is in contrast to classical windows which are inserted into the thickness of the wall and which, owing to this fact, diminish the possible dimensions of the viewing aperture, the diminution being equivalent to the width of the frame. Moreover, this likewise permits a thermal optimization of the insulating glazing under vacuum. Indeed, when the viewing aperture is of a dimension almost identical to that of the opening, the glass structure is of a dimension greater than that of the opening and, as a result, one creates an overlap of the glass structure and of the masonry. Such an overlap insulates the most thermally vulnerable point of the glass structure, namely the peripheral sealing for the insulating glazing under vacuum. Thus, creation of a thermal bridge is avoided, and the insulation obtained by the unit is improved. Moreover, materials such as aluminum, usually little used in the manufacture of windows or doors owing to their thermal conductivity, may be used. In fact, the insulation of the edge of the glass structure borne by the masonry is sufficient and thus permits the use of more or less conductive materials for the peripheral lining of the glass structure, given that the creation of a thermal bridge is greatly reduced.

According to a preferred embodiment of the invention, the seals are formed peripherally on the sash, either on the sash or on the frame, or partially on the sash and partially on the frame. Installing such seals provides improved tightness between sash and frame. According to a variant of the invention, the seals installed on the sash are either on the glazing or on the lining. Thus, when the glazing is not lined on the face in contact with the frame, a seal is created between the frame and the glazing itself According to an advantageous variant of the invention, the seals are deposited by extrusion. This way, the seals are perfectly continuous, which allows perfect tightness to be obtained.

The window or door of the invention allows, as previously explained, a better adaptation to masonry structures, to different dimensions of the opening and/or to faults of the masonry in the opening or on the surrounding wall, than do traditional windows or doors. It is likewise easier to install and permits using standard hardware accessories. It can, furthermore, be more easily stylized to personal taste thanks to various lining possibilities. The window or door according to the invention can appear in preassembled form or in the form of separate elements (these elements being at least the frame, the glass structure and the lining of the glass structure previously defined), the elements being assembled and the window or door being installed by the final user.

The windows or doors of the invention are positioned simply on the wall of the chamber to be closed, due to their thinness and the rigidity of the insulating glazing, which permits eliminating a voluminous border or framing. As a consequence, it is possible to install the frame directly on the wall of the chamber without having to fill in an empty space while, at the same time, attempting to reach a level of tightness which is often difficult to obtain.

Such a window or door in which the frame is positioned on a wall brings other advantages. It permits having a standard glazing model for a great number of dimensions of openings. In fact, assuming that the frame can be fixed directly in the wall, it is possible to adjust the dimensions of the lining or the depth of the glazing flange used during lining, for example, to adapt a glazing to an opening of dimensions less than those of the glazing or in the reverse case, to adjust the dimensions of the frame in order to adapt a glazing to an opening with dimensions greater than those of the glazing.

Moreover, such a window or door can be opened by a “sliding” type system on rails which permits a 100% opening, the sash sliding so as to be totally superposed on part of the chamber wall. In fact, the traditional sliding devices require an overlapping of at least two glazings, which leads to a partial closing of the opening.

### BRIEF DESCRIPTION OF THE DRAWINGS

Details and advantages of the invention will emerge from the description of embodiments of the invention with reference to the attached Figures, wherein:

FIG. 1 is a horizontal section of a window with folding panel of the invention,

FIG. 2 is a vertical section of the same window according to the invention,

FIG. 3 is a horizontal section of a window with two folding panels of the invention,

FIG. 4 is a vertical section of the same window with two folding panels of the invention,

FIG. 5 is a horizontal section of a second window with two folding panels of the invention,

FIG. 6 is a vertical section of the second window with two folding panels of the invention, and

FIG. 7 is a horizontal section of a third window with two folding panels of the invention.

### DETAILED DESCRIPTION OF THE PREFERRED EMBODIMENT

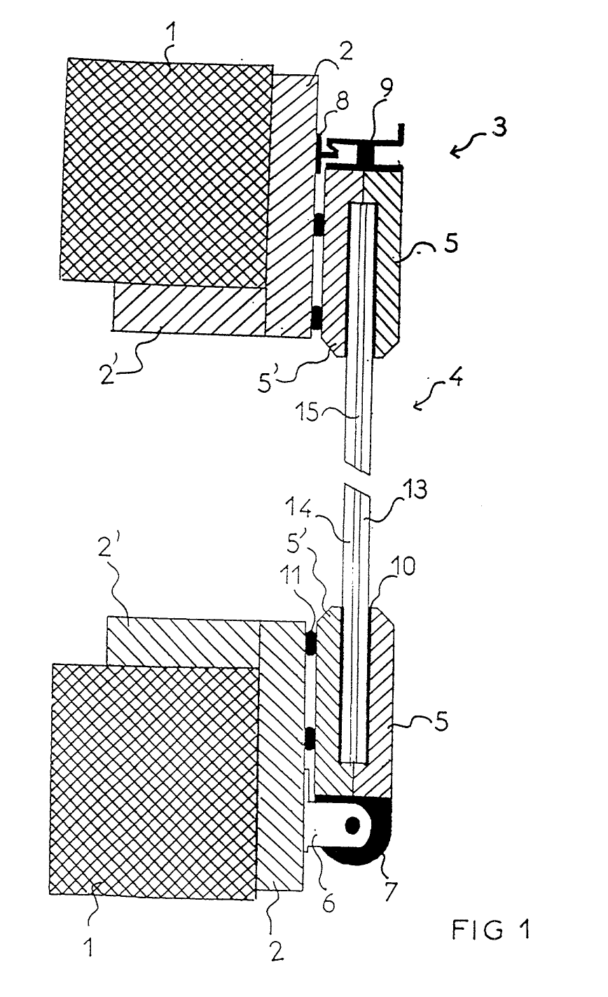

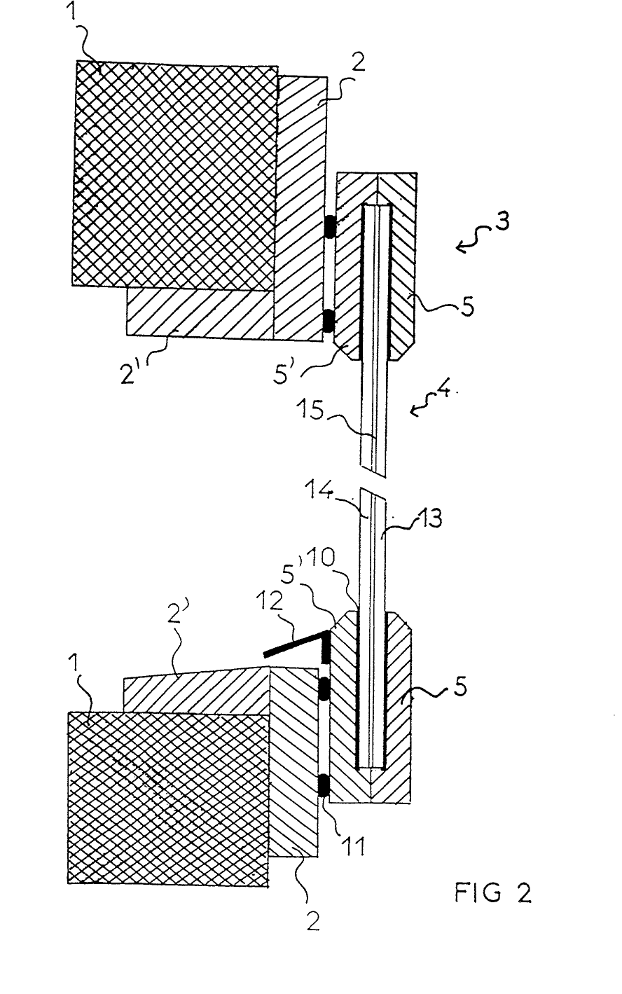

A window with one folding panel of the invention is shown in FIGS. 1 and 2. It includes a frame 2, 2′, a sash 3 including an insulating glazing 4 under vacuum, and a lining 5, 5′. The frame 2, 2′ is installed on the wall 1 of a chamber to be closed. It includes, for example, panels or sheets of wood, aluminum, PVC or any other known materials. The frame 2 is directly attached in the wall 1 by any known means, for example by screws. These attachments means are not shown in the Figures. Hardware elements 6 and 8 used in the opening and closing of the window are fixed on the lateral edges of the frame 2′.

The sash 3 is mounted on the frame 2 and includes the insulating glazing under vacuum 4. This insulating glazing under vacuum 4 is comprised of two sheets of glass 13 and 14 separated from each other by a space 15 in which the vacuum is created. This glazing 4 is specifically described in the patent application EP-A-645 516.

The glazing 4 has the lining 5, 5′ on its two peripheral faces. The lining 5, 5′ can include two panels of wood, aluminum, PVC or any other known material and is adhered, for example, by bonding using, for example, a single component or dual component silicone adhesive 10.

Elements 7 and 9 complementary to the elements 6 and 8 are fixed on the lateral edges of the lining 5, 5′. The unit of elements 6 and 7 permits a rotation of the sash on one of its edges and the unit of elements 8 and 9 permits the latching of the sash 3 on the frame 2. Of course, the invention is not limited to these elements 6, 7, 8 and 9; any other known hardware elements can be used in the window of the invention.

Seals 11, for example of PVC, compressed between the frame and the sash assure tightness between the sash 3 and the frame 2. The seals 11 can, for example, be deposited by extrusion directly on the lining 5′, directly on the frame 2 or partially on the lining 5′ and partially on the frame 2.

Referring to FIG. 2, a conventional drip molding 12 is fixed on the lining 5′ exterior side in the lower part of the sash 3. This element 12, shown in a simplified manner, permits water removal in the event of, for example, bad weather.

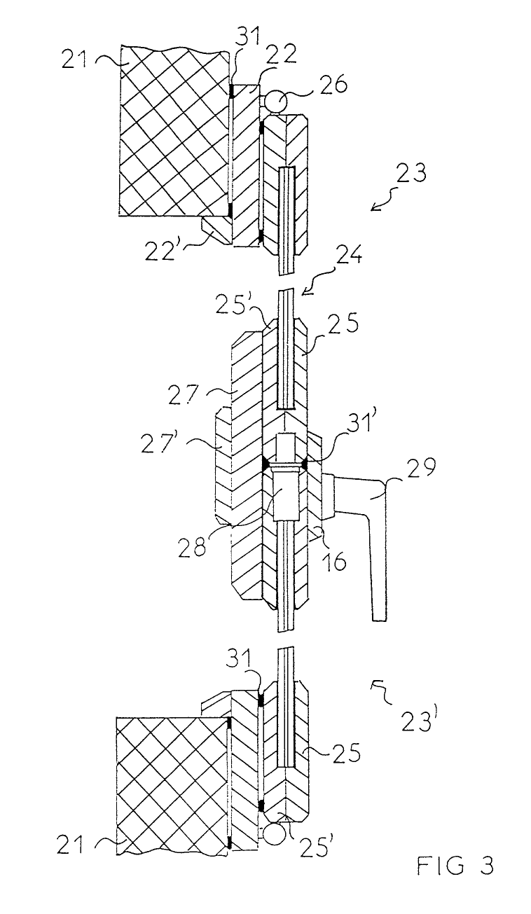

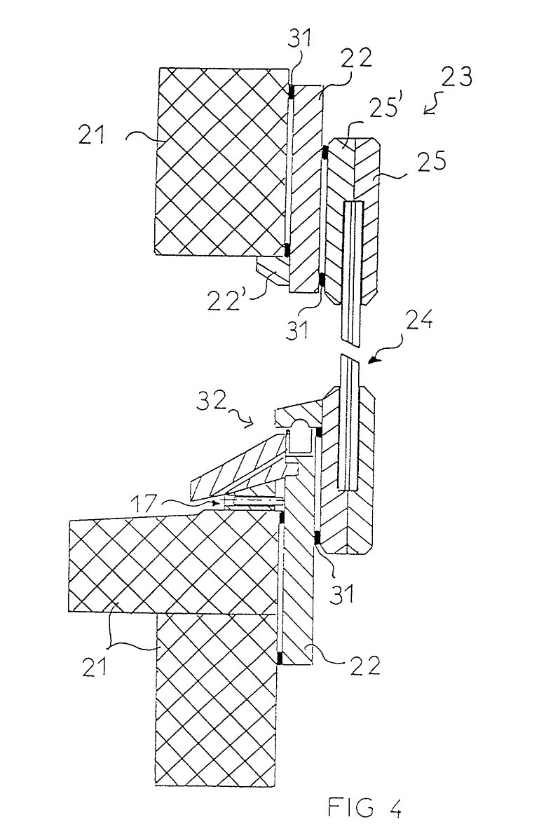

A window with two folding panels of the invention is shown in FIGS. 3 and 4. It includes a frame 22, 22′, 27, 27′, and a sash having flaps 23, 23′ composed of two insulating glazings under vacuum 24 and linings 25, 25′. The frame 22, 22′ is positioned on the wall 21 of a chamber to be closed. The tight seal between the frame 22, 22′ and the wall 21 is realized using compressed seals 31, and the attachment elements onto the wall 21 are not shown. The sash 23, 23′ is mounted on the frame 22, 22′, 27, 27′. The glazings 24 include the lining 25, 25′ on the periphery of their two faces. Tightness between the frame 22 and the sash 23, 23′ is realized using compressed seals 31.

Part of the frame 27, 27′ is situated in the central part of the wall opening to be closed and separates this opening in two, heightwise. The two flaps 23, 23′ each have one insulating glazing 24. The linings 25, 25′ are made such that when the two flaps of the sash 23, 23′ close the opening, they are situated opposite each other and rest on part of the frame 27. In order to create a seal between the frame 27 and the two flaps of the sash 23, 23′, seals 31′ are formed at the joint between the two linings 25, 25′. Thus, on the face resting on part of the frame 27, there is a seal 31′ sealing between the frame 27 and the two linings 25′, and on the opposite face that is oriented toward the interior of the chamber, there is a seal 31′ sealing between the two linings 25 and an element 16 situated atop the two linings 25. This element 16 is comprised, for example, of a panel constructed of an insulating material corresponding to the material of the lining 25 of the glazings 24, and is fixed by any known means to one of the flaps of the sash, here the flap 23′, directly on the lining. The element 16 minimizes the thermal bridge at the juncture of the two flaps of the sash 23, 23′.

Hardware elements 26 used in the rotation of the flaps of the sash are fixed on the lateral edges of the sash 23, 23′ and on the opposing edges of the frame 22, and hardware elements 28 and 29, such as for example, a lock bolt, which aid in latching the window, are integrated into the flap 23′.

A drip molding 32 is fixed on the lower part of the lining 25′ exterior side and on the frame 22. Under this element 32 there is a beveled block system with an adjustment screw 17 which permits the vertical level of the frame 22 to be set.

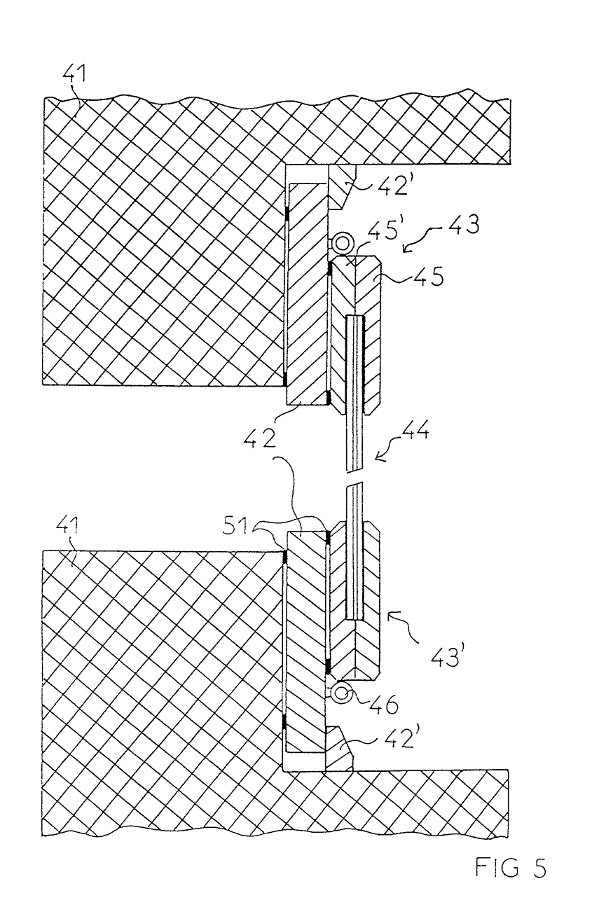

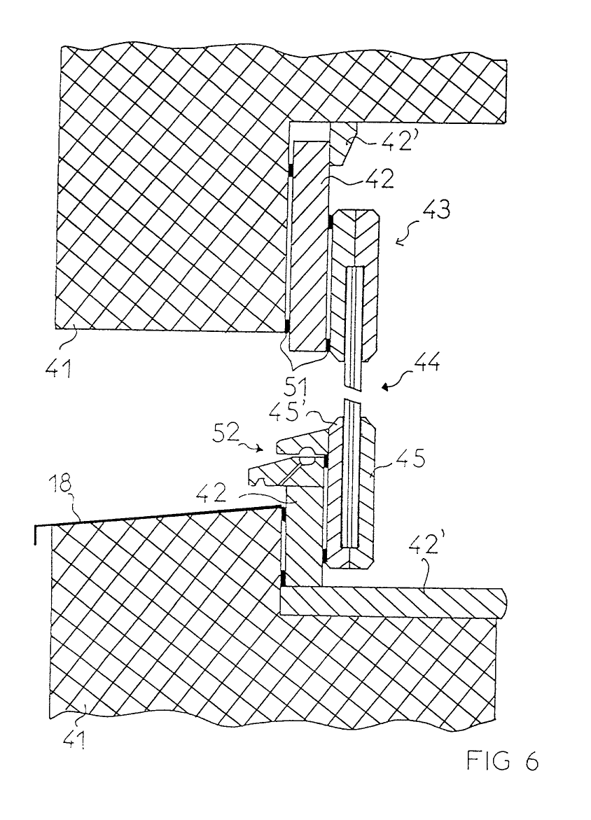

FIGS. 5 and 6 show a second type of window with two folding panels of the invention. It is composed of a frame 42, 42′ and a sash 43, 43′, itself consisting of two insulating glazings under vacuum 44 and a lining 45, 45′. The frame 42, 42′ is positioned on a jamb situated within the wall 45 of a chamber to be closed, and the sash 43, 43′ is mounted on the frame. In this way, the window is set back from the general plane of the wall and thus forms a niche in the wall 41.

In the same way as in the two preceding examples, sealing between the various elements is realized using compressed seals 51, hardware elements such as hinges 46 are used, and the interior edge of the window includes a drip molding 52. A protective element 18 covers the exterior edging of the window.

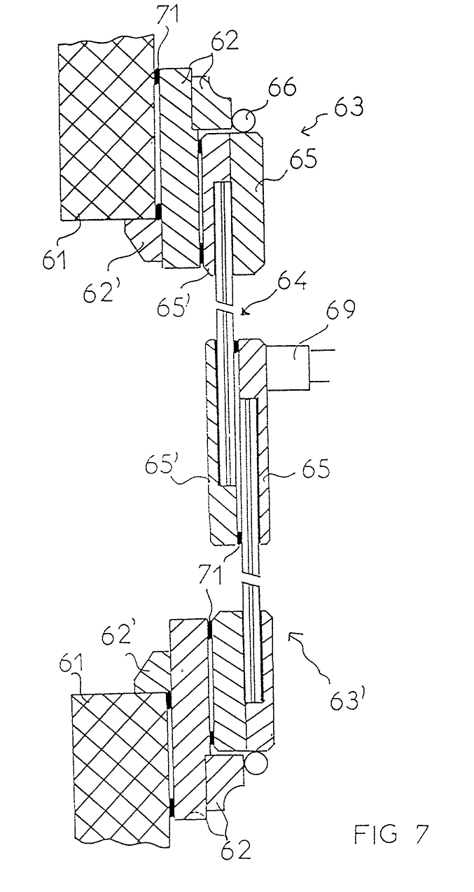

FIG. 7 shows a third way of creating a window with two folding panels. It includes a frame 62, 62′ and a sash 63, 63′, itself consisting of two insulating glazings under vacuum 64 and a lining 65, 65′. The frame 62, 62′ is mounted on the wall 61 of a chamber to be closed, and the sash 63, 63′ is mounted on the frame. The seal between the various elements is realized using compressed joints 71, and hardware elements such as hinges 66 and a lock bolt 69 are used.

In this embodiment, the windows 64 are not positioned on the same plane and their extremities overlap. For this purpose, one of the glazings 64 is fitted in lining 65 and the other in lining 65′. The facing parts of the glazings 64 overlap in contact with one another, at which location each glazing has only a single lining. This way, the thermal bridge at the joint of the glazings is minimized without requiring an additional element. In order to form a tight seal between the two faces of the glazings in contact, seals 71 are formed between them, by extrusion for example.

Of course, the invention is not limited to these embodiments using folding panels, and windows including a sliding or fixed sash also fall within the scope of the invention. Likewise, the invention is not limited to insulating glazings under vacuum. Any other glass structures possessing a good rigidity fall within the scope of the invention. By good rigidity is meant a structure which is not fragile and may be the weight bearing element of a window or door.

What is claimed as new and desired to be secured by Letters Patent of the United States:

1. Window or door comprising:
a frame applied against a wall of a chamber including an opening to be closed; and
a sash movably mounted to said frame and comprising an insulating glazing including at least two sheets of glass.

2. Window or door according to claim 1, wherein the frame is applied against the interior wall of the chamber.

3. Window or door according to claim 1, wherein the frame is applied against the exterior wall of the chamber.

4. Window or door according to claim 1, wherein the frame is positioned against a jamb situated in the thickness of the wall of the chamber.

5. Window or door according to claims 1, wherein the frame is manufactured in situ.

6. Window or door according to claim 1, wherein the frame includes support adjustment means for mitigating faults in the evenness of the wall.

7. Window or door according to claim 1, wherein the frame includes means for setting the height of the frame in relation to the opening.

8. Window or door according to claim 1, including compressed seals on a face of the frame opposite to the wall.

9. Window or door according to claim 8, including a mastic applied between the frame and the wall.

10. Window or door according to claim 1, wherein the insulating glazing comprises a vacuum space between layers of the glazing.

11. Window or door according to claim 1, wherein the dimensions of the insulating glazing are at least as great as those of the opening.

12. Window or door according to claim 1, wherein the sash includes a lining on at least the periphery of one face thereof.

13. Window or door according to claim 12, wherein the lining is bonded to the sash.

14. Window or door according to claim 13, wherein an adhesive used for the bonding has a shearing resistance greater than 0.25 kg/cm² for a bonding surface of 800 cm², this resistance being inversely proportional to the bonding surface used, and has a resistance to heat of at least 130° C.

15. Window or door according to claim 12, wherein the glazing is embedded in grooves of the lining.

16. Window or door according to claim 1, wherein a viewing aperture of the window or door is of a dimension almost identical to that of the opening.

17. Window or door according to claim 1, including seals positioned between the periphery of the sash and the frame.

18. Window or door according to claim 17, wherein the seals are deposited on one of the glazing and the lining.

19. Window or door according to claim 17, wherein the seals are extruded seals.

20. Window or door according to claim 1, and in the form of detached elements capable of being assembled to yield the window or door.
